(19) United States
(12) Patent Application Publication
(10) Pub. No.: US 2004/0034765 A1
(43) Pub. Date: Feb. 19, 2004

(54) Method and apparatus for booting a computer system

(76) Inventor: O?apos;Connell Daniel James, Auckland (NZ)

Correspondence Address: YOUNG & THOMPSON, 745 SOUTH 23RD STREET 2ND FLOOR, ARLINGTON, VA, 22202

(21) Appl. No.: 10/266,694

(22) Filed: Oct. 9, 2002

(30) Foreign Application Priority Data
Aug. 14, 2002 (NZ) 520786

(51) Int. Cl. G06F 9/00

(52) U.S. Cl. 713/1

(57) ABSTRACT

A method for quickly booting a personal computer system using a Flash Memory device. A compressed memory image of the contents of the system working memory when the system is in a desired operational state is stored in the Flash Memory. The image can be captured during a set-up process or when the computer system is shut down. When the user restarts the computer the memory image is decompressed and loaded into the working memory. This places the computer in an operational state in a very short space of time.

### FIELD OF THE INVENTION

This invention relates to booting a computer system or other digital processing device, and has particular relevance to desktop computer systems and personal computers including mobile computing devices.

### BACKGROUND OF THE INVENTION

From a cold or hard boot the first program that a personal computer typically runs is a set of instructions loaded in ROM which contains the information required to initialise the system hardware and enable the machine to activate a hard disk drive to find the boot-strap loader.

Therefore, at present, operating systems load boot information and files from the local hard disk drive into the working or system memory, commonly called RAM. This information usually includes file system drivers, the operating system kernel, and configuration and device information that have to be parsed into useful information, and general cosmetic customisations.

Because of the sheer number and size of these files, computers often take several minutes to boot i.e. to get to a useable state, which end users often find very frustrating.

The time taken to boot a personal computer can have a significant impact on worker productivity. Personal computers are widely used in workplaces, particularly in office environments. In a large office the time spent waiting for computers to boot can result in a large quantity) of unproductive time. If personnel are using mobile personal computers which are taken to meetings throughout the working day, then the problem is magnified. Furthermore, it is not uncommon to have to re-boot a personal computer due to an operating system error that simply occurs as a result of use of the computer.

Furthermore, in some environments the continuing functionality of a computer system or other digital processing device can be very important, for example the control of a communication system or a production process. Therefore, down time resulting from a system failure or “crash” must be kept to a minimum.

The Advanced Configuration and Power Interface (ACPI) specification enables boot times to be reduced but even systems that implement this specification usually require users to wait at least 30 seconds before they can use their computers.

### OBJECT OF THE INVENTION

It is an object of the present invention to provide a method and apparatus for booting a computer system which will at least go some way toward overcoming disadvantages of the prior art, or which will at least provide the public with a useful choice.

Alternatively, it is an object of the present invention to provide a method or apparatus for booting a computer system which will reduce the time required for existing systems to boot.

### SUMMARY OF THE INVENTION

The invention provides a method of booting a digital processing device such as a computer system. The system has a working memory and the method includes the steps or providing a memory image of contents of the system working memory and loading the memory image in a Flash Memory. When the system is required to boot, the memory image from the Flash Memory is loaded into the system working memory, thereby booting the system in a very short space of time.

In a preferred embodiment the system is adapted to boot from either Flash Memory or the system hard drive. With either method the system loads the memory image from Flash Memory into RAM, restoring the operating system to its previous working state.

Preferably the set-up application for the desired operating system additionally creates a Compressed Memory Image (CMI), containing a compressed image of all data currently stored in RAM, such as is currently implemented in the ACPI 2.0a specifications as a State S4 system context file. This file is stored in the Flash Memory, but the set-up application does not shut the computer down as is the case for a State S4 system context file creation in the current ACPI 2.0a specifications.

When the user restarts the computer, for example by pressing a power “on” button, the BIOS either looks to Flash Memory for boot information, or alternatively looks on the hard drive. The computer then proceeds through the normal POST boot method, and modified operating system boot loaders then transfer and decompress a previously created Compressed Memory Image (CMI) from Flash Memory into main memory or working memory (RAM). This effectively restores the computer to its previous powered on state, and the user simply enters his or her password (if required) and begins using the computer as normal.

When the user wishes to shut down the computer system, the operating system first checks as to whether any significant changes have been made to the configuration of the computer. If there are no significant changes the operating system simply shuts down the computer in a was similar to known shut down procedures, but does not save any new system configuration data. If significant changes have been made, then in a preferred embodiment the operating system saves and compresses all data currently stored in RAM to a new CMI located in Flash Memory, and saves the previous memory images for recovery and troubleshooting.

The invention further provides a computer system including a Flash Memory which contains a memory image of contents of the system working memory.

The memory image may be an image of the system working memory in a certain state desired by a user, including a state immediately post-boot, or a state in which certain applications are open. The memory image may be an image of only the operating system, or may be a partial image. The memory image is preferably a compressed memory image (CMI) which is decompressed before or as it is being loaded into the system working memory.

In a preferred form, the memory image comprises a compressed memory image. Furthermore, the system includes a disk drive or other storage device which includes at least one archived copy of the memory image or the compressed memory image.

The invention also provides a method of shutting down a computer system which includes the step of storing a compressed image of all data currently stored in RAM as a Compressed Memory Image (CMI) in the Flash Memory, and storing one or more archive copies of the CMI on another storage device such as a local hard drive of the system.

Preferably the operating system source code is modified to internally support a flash file system (FFS) through a Flash Translation Layer (FTL), such as Intel's own FTL specification (http//www.intel.com/design/flcomp/applnots/297816.htm).

It is also preferred that the BIOS of the computer is modified to boot from Flash Memory using a flash file system (FFS) and File Translation Layer (FTL).

Conveniently the compressed memory image (CMI) has the compressed version of all data currently stored in RAM resulting from a previous shut down procedure, similar to a State S4 shutdown procedure in the current ACPI 2.0a specifications.

In the most preferred embodiment the previous CMI is archived to installed and Flash Memory to be used as a “last known good” CMI.

### BRIEF DESCRIPTION OF THE DRAWINGS

FIG. 1 is a flow diagram of a computer boot or start-up process according to the invention,

FIG. 2 is a flow diagram of a shutdown process according to the invention, and

FIG. 3 is a diagrammatic representation of a computer system including a Flash Memory for use with the boot process and shut down process of the preceding Figures.

### DETAILED DESCRIPTION

The examples referred to below relate to use of the invention to boot a personal computer and to a personal computer having a Flash Memory configured to effect booting the computer. However, the invention is also applicable to other digital processing devices which require an operating system to be loaded for use, for example computer game machines, business machines and telecommunication apparatus.

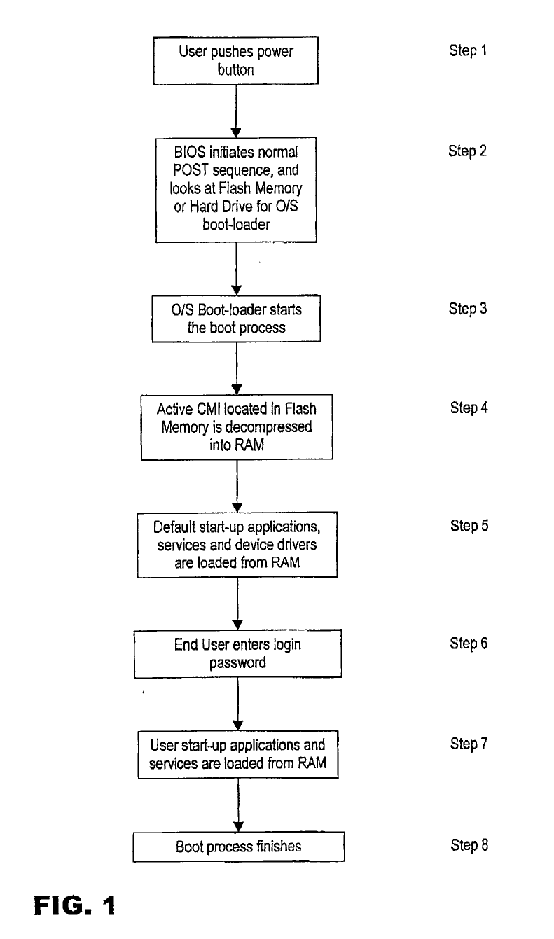

Referring to FIG. 1, a flow diagram of a boot or start up process for a computer system according to the invention is illustrated.

The method described with reference to FIG. 1 assumes that a “cold” or “hard” boot is being, performed. Those skilled in the all will see that the method is also applicable to situations where a “warm” or “soft” boot is performed.

Referring to FIG. 1, a user activating the system power button for example in step 1. This applies power to the system and, in the usual way, the BIOS software initiates the boot sequence. Therefore in step 2, the BIOS is activated, performs its usual POST initialisation sequence, and then does one of two things. The BIOS either: a) looks to the hard drive of the system for the operating system boot loader, as occurs in existing boot sequences; or (b) Alternatively, the BIOS looks to a Flash Memory provided in the computer system. Even if the BIOS initially looks to the hard drive for the operating system boot loader, the boot loader still directs the system to download a memory image from the Flash Memory, as will be described further below.

The Flash Memory is provided as an integrated circuit, which is accessible to the computer system, for example being provided on the motherboard of the personal computer. Alternatively, it is provided as a PCI add-in card to retrofit to an existing machine. The Flash Memory may also be provided in other ways, so long as it satisfies requirements of being accessible to the system to enable its contents to be accessed sufficiently quickly by the system to make the boot method of the present invention worthwhile.

Turning now to step 3, the operating system boot loader starts the boot process either directly from the contents of the Flash Memory, or from the hard drive of the system.

The Flash Memory contains a memory image of the contents of RAM which are sufficient, when loaded into system memory, to enable the computer system to be provided in a useable state for a user i.e. to boot the computer system.

Depending upon the requirements of the user, the memory image that is captured and provided in the Flash Memory may take a variety of forms. For example, the Flash Memory may contain a memory image of the post-boot system working memory (i.e. RAM) contents.

Another alternative for example, is to load the Flash Memory with a preferably compressed memory image of all data currently stored in RAM. In a preferred form, this compressed memory image is stored from a previous shutdown procedure similar to a State S4 shutdown procedure in the current ACPI 2.0a specifications. This includes computer and/or operating system settings of the computer system where it is in a state ready for use by a user, and is preferably provided to a user for a user to resume use of the system where it is in a condition which is the same or substantially the same as it was when the user commenced shutdown.

Details of a standard ACPI S4 shutdown can be found from the current ACPI specification, Revision 2.0, which is available at http://www.acpi.info.

The memory image may also be only a partial image of the system memory. Therefore, the image may comprise data relating to the bulk or the operating system for example, and the remainder of the information necessary to build or establish the system working memory may he loaded into the working memory from another memory storage device such as the system hard disk. This arrangement may be preferable where the size of the Flash Memory needs to be limited for example due to cost constraints, but the invention is still worthwhile because the overall time taken to perform a boot process is still significantly reduced as compared to known boot processes.

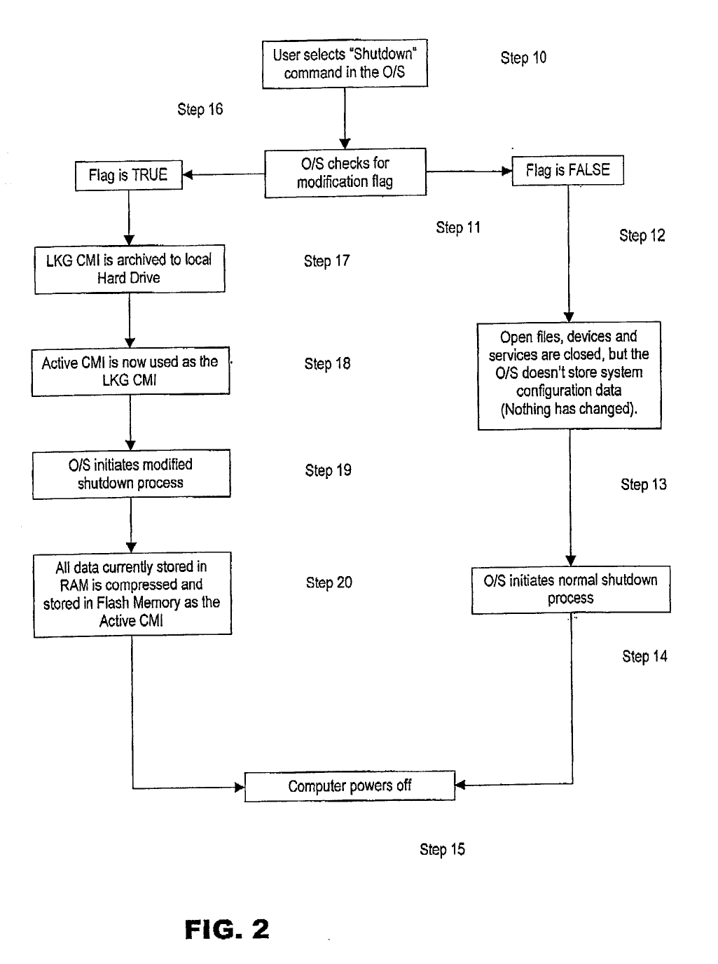

The memory image may be initially created during the set up process of the operating system, or may alternatively be replaced whenever a user makes a significant change to the configuration of the computer. Also, the memory image may be captured every time the user initiates a shut down sequence. These options are discussed further with reference to FIG. 2.

The memory image is preferably compressed, so that a compressed memory image (CMI) is stored in the Flash Memory and retrieved from the Flash Memory when required. Compression can save a significant amount of memory space without the decompression process adding significantly to the reduced boot time provided by the present invention.

Turning now to Step 4 of FIG. 1, the CMI located in the Flash Memory is decompressed, and the computer system settings and full memory contents are loaded into RAM from the decompressed CMI.

In step 5, start up applications services and device drivers are loaded from RAM. The system is now ready for the user to log one as shown in step 6 where the user can enter a log on identifier and password. User related start up applications and services are loaded from RAM, as shown in step 7. The process is now completed as indicated by step 8.

Because the memory contents are loaded very quickly from the Flash Memory into RAM, rather than being searched for and transferred from the system hard disk, the time required for the boot process is dramatically reduced.

In one example of booting a personal computer (PC) using the Microsoft Windows™ operating system, the BIOS checks the Flash Memory for boot information first, and loads the windows boot files and kernel into memory. The registry hives may be created and stored in a Flash Memory if storage space permits, or they may be created and stored on the local hard drive, as with the case with existing systems. While Windows is loading, device drivers will be loaded into RAM from Flash Memory. Services and third party start-up applications will be pre-loaded from the local hard drive. A typical personal computer may be physically modified to implement this process by providing a 64 or 128 megabyte (up to 1 GB) Flash Memory chip(s) added to the motherboard of the machine. The BIOS on the PC is modified to allow booting from the Flash Memory using built in support for a flash file system (FFS) and Flash Translation Layer (FTL). Microsoft Windows™, for example Windows XP, will be modified to support the FFS/FTL through internal drivers (e.g. FAT16/32, NTFS, and FFS/FTL) or third party drivers. Hardware support can be provided through an add-on PCI based product. Windows boot files and device drivers are added to the Flash Memory, and third party start up programs are physically moved to the start of the hard drive.

In another example using a Windows operating system, the BIOS boots from Flash Memory, and loads and decompresses the memory image into RAM. Minor environmental changes are loaded or created from the beginning of the hard drive after the memory image is in RAM. These include (but are not limited to) the following:

Application installations

Non-critical start-up applications

Registry hives

Page file (virtual memory)

Physical modifications to a typical personal computer running Microsoft Windows operating system are similar to those referred to in the example above, however a user customised 128 megabyte (up to 1 GB) compressed Windows memory image is created during Windows setup, and is stored in Flash Memory. Further customised settings are stored at the beginning of the hard drive.

Turing now to FIG. 2, a shut down process for a computer system according to the invention is diagrammatically illustrated. The process begins in step 10 with the user selecting a shut down command from the operating system. The operating system, as part of the shut down process, then checks for a modification flag in step 11. The modification flag is one that is set by the operating system whenever a significant change is made to the configuration of the computer. A significant change may include (without limitation) the following:

(a) new application installations

(i) application installations that require components to load once the operating system boots

(b) changes to registry hives

(c) device driver upgrades

(d) service pack/hotfix installations

(e) service modifications

(f) user environment customisations

(i) desktop

(ii) wallpaper

(iii) themes

(iv) sounds

(v) icons

(vi) colour schemes

Therefore, with each new user session from a boot up the modification flag is set to false. Then, when a significant change occurs, such as changes listed above for example, then the flag is set to true. For purposes of clarity, the list of significant changes provided above is not exhaustive. Furthermore, a user may wish to exclude some of the actions from the list provided above.

Returning to FIG. 2, if the modification flag is false as shown in step 12, then the operating system closes all open files, devices and services but does not save any system configuration data since nothing in that area has changed, as shown in step 13. The operating system then continues its normal shut down process, currently implemented in the ACPI 2.0a specifications as a State S5 Shutdown, in step 14. The computer is then in a state where it either switches itself off in step 15, or prompts a user to switch the machine off.

If the modification flag is true as shown by step 15 in FIG. 2, then the “last known good” (LKG) compressed memory image is archived to an appropriate storage means such as the system's local hard drive. This occurs in step 17.

Then, in step 18, the CMI that was used to last boot the system, being the active CMI, is now used as the LKG CMI.

The operating system then initiates a modified shut down procedure, as shown in step 19.

In step 20 all data currently stored in RAM is compressed using an appropriate compression algorithm and loaded into the Flash Memory to become the new Active CMI. The operating system then finishes the modified shut down process as described above with reference to step 15.

From the method shown in step 2 it can be seen that an archive of compressed memory images which may be used to boot the system is retained. In this way, if a user makes a significant change which is deleterious to the operation of the machine i.e. is undesirable, or if the system crashes, a user will always have a compressed memory image from which the machine may be rebooted.

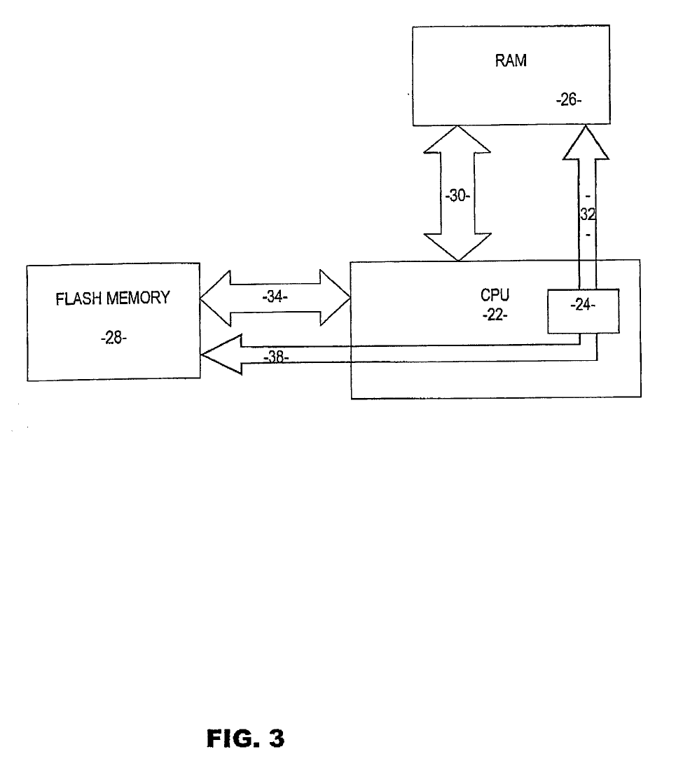

Turning now to FIG. 3, the basic processor and memory components of an example of a computer system according to the present invention are shown. To those skilled in the art to which the invention relates other arrangements and communication paths for the memory devices are possible. The system has a central processing unit (CPU) 20 within which is provided a control unit 22. Working memory in the form of random access memory (RAM) 26 is provided, as is a Flash Memory 28. A data bus 30 allows data to be interchanged between RAM 26 and the CPU 22 under control of the control unit 24 via address data control bus 32. Similarly, a data bus 34 allows data to be interchanged between the Flash Memory 28 and CPU under control of the control unit 24 via address data control bus 38. Therefore, bus 34 allows information in RAM comprising the entire memory content to be transferred to Flash Memory 28. Buses 30 and 34 may comprise a system bus. Furthermore, the content of RAM 26 may have been subject to compression whereby the compressed image may be transferred via bus 34 to be stored in Flash Memory 28. Then, when required, the memory image stored in Flash Memory 28 may be transferred directly to RAM 26, or may firstly be compressed and then installed in RAM 26.

The Flash Memory 28 has the advantage that it is essentially a solid state device which is non-volatile so the contents of the Flash Memory are retained when the power supply is removed from the computer system. However, those skilled in the art will appreciate that references in this document to Flash Memory include the use of flash RAM i.e. the forms of Flash Memory which require a source of external power such as a battery for example in order to maintain the memory content.

A Flash Memory device according to the invention may be provided as an integrated circuit on the system motherboard for example, or on a separate board or card. In particular, if desired, Flash Memory may be provided on a card such as those referred to under the trade marks SmartMedia or CompactFlash.

Some Flash Memory products that are currently available have twenty-five nanosecond load times, so it will be seen that the method and system according to the present invention provides significant advantages in terms of boot times compared with prior art systems.

Also since Flash Memory products are becoming available at reasonable prices it will be seen that the invention provides a system which is relatively inexpensive, easy to install whether as a retrofit system to existing products or to new products, and does not require any change to user habits.

References in this document to computer systems include digital data processing systems generally.

Throughout the description and claims of this specification the word “comprise” and variations of that words such as “comprises” and “comprising”, are not intended to exclude other additives, components, integers or steps.

1. A method of booting a computer system having a system working memory, the method including the steps of:
providing a memory image of desired contents of the system working memory,
loading the memory image in a Flash Memory, and
upon the system being required to boot, loading the memory image from the Flash Memory into the system working memory.

2. A method as claimed in claim 1 wherein the step of providing a memory image of desired contents of the system working memory includes the step of providing a memory image of post-boot contents of the system working memory.

3. A method of booting a computer system as claimed in claim 1 wherein the step of providing a memory image of desired contents of the system working memory includes the step of providing a memory image which is an image of all data stored in the system working memory prior to the computer system last being shut down.

4. A method as claimed in claim 1 including the step of compressing the memory image and loading the compressed memory image into the Flash Memory, and decompressing the compressed memory image so that the decompressed memory image is loaded into the working memory.

5. A method as claimed in claim 1 including the step of creating the memory image during the set up process of the operating system.

6. A method as claimed in claim 1 including the step of updating the memory image in response to a significant change to the configuration of the system.

7. A method as claimed in claim 4 wherein the updating step includes the step of archiving the last known good memory image, or last known good compressed memory image.

8. A method as claimed in claim 1 including the step of modifying the operating system source code to support a flash file system and/or a Flash Translation Layer (FTL).

9. A method as claimed in claim 1 including the step of modifying the BIOS to boot from the Flash Memory.

10. A method as claimed in claim 1 wherein the memory image is an image including all system settings and memory contents.

11. A method as claimed in claim 1, wherein operating system boot files or similar data is stored on Flash Memory.

12. A computer system including:
a digital processing means,
a working memory for the digital processing means,
a Flash Memory including a memory image of desired contents of the system working memory, the Flash Memory being capable of transferring the Memory image to the system working memory in order to boot the computer system.

13. A computer system as claimed in claim 12 wherein the memory image comprises a compressed memory image.

14. A computer system as claimed in claim 12 wherein the system includes a disk drive or other memory storage device including at least one archive copy of the memory image.

15. A computer system as claimed in claim 12 wherein the memory image is an image of desired post-boot contents of the existing working memory.

16. A computer system as claimed in claim 12 wherein the memory image is an image of all data stored in the working memory prior to the computer system being shut down.

17. A computer system as claimed in claim 12 wherein the memory image was created during a setup process of an operating system of the computer system.

18. A computer system as claimed in claim 12 wherein the system includes a disk drive or other memory storage device including at least one “last known good” copy of the memory image.

19. A method of shutting down a computer system having a system working memory, the method including the steps of:
creating a memory image of the contents of the system working memory,
loading the memory image in a Flash Memory, and
shutting down the computer system.

20. A method as claimed in claim 19 including the step of compressing the memory image prior to loading the memory image in the Flash Memory.
